(19) United States
(12) Patent Application Publication
(10) Pub. No.: US 2009/0324256 A1
(43) Pub. Date: Dec. 31, 2009

(54) Optical transmitter

(75) Inventors: Hiroshi Kuzukami, Kawasaki (JP); Tsuyoshi Morishita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/379,686

(22) Filed: Feb. 26, 2009

(30) Foreign Application Priority Data
Jun. 27, 2008 (JP) 2008-168129

(51) Int. Cl. H04B 10/12

(52) U.S. Cl. 398/200

(57) ABSTRACT

In an optical transmitter, a laser emits light. A laser driving controller controls driving of the laser by superimposing modulation signals on laser driving signals to generate laser driving superimposed signals and by applying the laser driving superimposed signals to the laser to cause wavelength fluctuations in laser output light to suppress nonlinear optical phenomena during optical fiber transmission. An optical power variable controller variably controls a power of the laser output light. An optical fluctuation compensator suppresses optical fluctuations by monitoring output light from the variable controller to detect optical fluctuations accompanying wavelength fluctuations from monitoring results and by controlling a gain of the variable controller.

### CROSS-REFERENCE TO RELATED APPLICATIONS

This application is based upon and claims the benefit of priority of the prior Japanese Patent Application No. 2008-168129, filed on Jun. 27, 2008, the entire contents of which are incorporated herein by reference.

### FIELD

The embodiment discussed herein is related to an optical transmitter for performing optical fiber transmission.

### BACKGROUND

An optical fiber communication system realizes a long repeater spacing by allowing high intensity light to enter an optical fiber to compensate for a transmission loss. However, an optical power allowed to enter an optical fiber is limited by nonlinear optical phenomena in an optical fiber. Particularly, nonlinear optical phenomena referred to as SBS (Stimulated Brillouin Scattering) limit a maximum input optical power.

The SBS is a phenomenon in which when allowing high intensity light to enter an optical fiber and transmitting the light through the fiber, a refractive index of the optical fiber is changed and a frequency of incident light is shifted to cause scattering.

When SBS occurs during optical fiber transmission, signal light is distorted to disable a long-distance transmission and therefore, the occurrence of SBS is suppressed to perform an optical transmission. A known method increases a wavelength spectral bandwidth (line width) of signal light to suppress the occurrence of SBS.

FIG. 10 illustrates signal light having an increased line width. In FIG. 10, a horizontal axis indicates an optical frequency, and a vertical axis indicates an optical power. A waveform G1 indicates signal light whose line width is not yet increased, and a waveform G2 indicates signal light whose line width is increased.

When the signal light having an increased line width as indicated by the waveform G2 is allowed to enter an optical fiber, the occurrence of SBS is suppressed and accordingly, a limit of an allowable input optical power to the optical fiber can be increased. This line width increase is realized by fluctuating with time a frequency (wavelength) of signal light to reduce an optical power at a unit frequency.

FIG. 11 is a block diagram of a conventional optical transmitter. Specifically, FIG. 11 is a block diagram of a conventional optical transmitter 100 having an SBS suppressing function. The optical transmitter 100 comprises a DFB (Distributed Feedback) laser 101, a DFB driver 102, an oscillator 103, a TEC (Thermo-Electrical Cooler) 104, an SOA (Semiconductor Optical Amplifier) 105, an external modulator 106, an APC (Auto Power Control) circuit 110 and a coupler Cp0. The APC circuit 110 includes a PD (Photo Diode) 111, an I/V converter 112 and an SOA driver 113.

An output control of signal light is performed as follows. The DFB driver 102 generates a DFB driving current for driving the DFB laser 101. The DFB laser 101 as a light source is mounted on the TEC 104 (corresponding to a Peltier element) for performing temperature stabilization by being applied with electrical signals. The DFB laser 101 oscillates at a given optical wavelength based on the DFB driving current.

The SOA 105 amplifies output light from the DFB laser 101. The coupler Cp0 branches output light from the SOA 105 into two, to give one branched light to the external modulator 106 and to give the other branched light to the APC circuit 110. The external modulator 106 externally modulates an intensity of the output light from the SOA 105 and outputs signal light having a predetermined transmission rate.

The PD 111 monitors the output light from the SOA 105 and converts it into a current signal. The I/V converter 112 converts the current signal into a voltage signal. The SOA driver 113 generates an SOA driving current based on the incoming voltage signal and the reference voltage such that the voltage signal from the I/V converter 112 has the same value as that of the reference voltage, thereby performing a gain control (APC) such that an output power of the SOA 105 is kept constant.

An SBS suppression control is performed as follows. The oscillator 103 supplies an oscillation signal to the DFB driver 102. The DFB driver 102 causes the oscillation signal to fluctuate the DFB driving current with time to fluctuate an oscillation wavelength of the DFB laser 101, thereby achieving the line width increase.

For example, when superimposing an oscillation signal from 20 to 100 KHz on the DFB driving current to fluctuate the DFB driving current to increase an amplitude to be fluctuated (amplitude to be modulated), an SBS suppression effect can be enhanced and accordingly, an allowable input optical power to an optical fiber can be increased.

A conventional method for suppressing the occurrence of SBS to perform optical transmission separately has a signal source for generating a current signal supplied to a DFB laser and a signal source for generating a current signal supplied to an SOA, thereby controlling the current signals independently (see, e.g., Japanese Laid-open Patent Publication No. 2006-261590 (paragraph numbers [0016] to [0020], and FIG. 1)).

As described above, to suppress the occurrence of SBS, the DFB driving current needs to be fluctuated to cause fluctuations in the optical wavelength. However, when fluctuating the DFB driving current, an amplitude of the output light from the DFB laser 101 also fluctuates with the fluctuations in the optical wavelength and as a result, transmission quality deteriorates.

FIG. 12 illustrates a state where optical output fluctuates. In FIG. 12, a horizontal axis indicates a time, and a vertical axis indicates an optical power. Output light G11 indicates a waveform of the output light from the DFB laser 101. Output light G12 indicates a waveform of signal light from the external modulator 106.

When fluctuating the DFB driving current, the output light G11 from the DFB laser 101 also fluctuates. When externally modulating the fluctuated output light G11 to generate the signal light and transmitting the signal light through optical fibers, fluctuations in the output light G11 appear as deterioration (interference deterioration) of a transmission waveform as indicated by the output light G12.

Here, signal light generated by intensity-modulating (externally modulating) the output light G11 at a level p1 is defined as s1. Signal light generated by intensity-modulating (externally modulating) the output light G11 at a level p2 is defined as s2. Signal light generated by intensity-modulating (externally modulating) the output light G11 at a level p3 is defined as s3. Signal light generated by intensity-modulating (externally modulating) the output light G11 at a level p4 is defined as s4. Signal light generated by intensity-modulating (externally modulating) the output light G11 at a level p5 is defined as s5. Signal light generated by intensity-modulating (externally modulating) the output light G11 at a level p6 is defined as s6. During the optical fiber transmission of the signal light beams s1 to s6, the signal light beams s1 to s6 interfere with each other and as a result, transmission deterioration occurs (when measuring such signal light on the receiving side, an eye pattern with a narrow eye (aperture) is measured).

FIG. 13 illustrates transmission characteristics deterioration caused by waveform interference. In FIG. 13, a horizontal axis indicates a light receiving level on the receiver side, and a vertical axis indicates a bit error rate (BER). A graph G13 indicates the transmission characteristics deterioration when no waveform interference occurs, and a graph G14 indicates the transmission characteristics deterioration when waveform interference occurs.

When the light receiving level is P1, the bit error rate when no waveform interference occurs is b1, whereas the bit error rate when waveform interference occurs is b2 (b1<b2). Accordingly, it is found that when the waveform interference occurs, the transmission characteristics greatly deteriorate.

As described above, to suppress the occurrence of SBS to increase the allowable input optical power to the optical fiber, the fluctuation range of the DFB driving current needs increasing. However, there may occur such a trade-off that when increasing the fluctuation range of the DFB driving current, the optical output fluctuations also increase and as a result, the transmission characteristics deterioration occurs. Recently, although increase in the allowable optical power to optical fibers has been demanded, the problem to be solved is to suppress the transmission characteristics deterioration which occurs when the SBS is suppressed.

### SUMMARY

According to an aspect of the embodiments, an optical transmitter for performing optical transmission includes: a laser which emits light; a laser driving controller which controls driving of the laser by superimposing a modulation signal on a driving signal for the laser to generate a laser driving superimposed signal and by applying the laser driving superimposed signal to the laser to cause wavelength fluctuations in laser output light to suppress nonlinear optical phenomena which occur during optical fiber transmission; an optical power variable controller which variably controls a power of the laser output light; and an optical fluctuation compensator which suppresses optical fluctuations by monitoring output light from the optical power variable controller to detect the optical fluctuations accompanying the wavelength fluctuations from monitoring results and by controlling a gain of the optical power variable controller.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a principle view of an optical transmitter according to an embodiment;

FIG. 2 illustrates a concept of compensation for optical fluctuations;

FIG. 3 is a block diagram of the optical transmitter according to the embodiment;

FIG. 4 illustrates a state in which the compensation for optical fluctuations is excessive;

FIG. 5 illustrates a state in which the compensation for optical fluctuations is insufficient;

FIG. 6 illustrates generation of the gain compensation amount in the case where the compensation is excessive;

FIG. 7 illustrates generation of the gain compensation amount in the case where the compensation is insufficient;

FIG. 8 is another block diagram of the optical transmitter according to the embodiment;

FIG. 9 is another block diagram of the optical transmitter according to the embodiment;

FIG. 10 illustrates signal light having an increased line width;

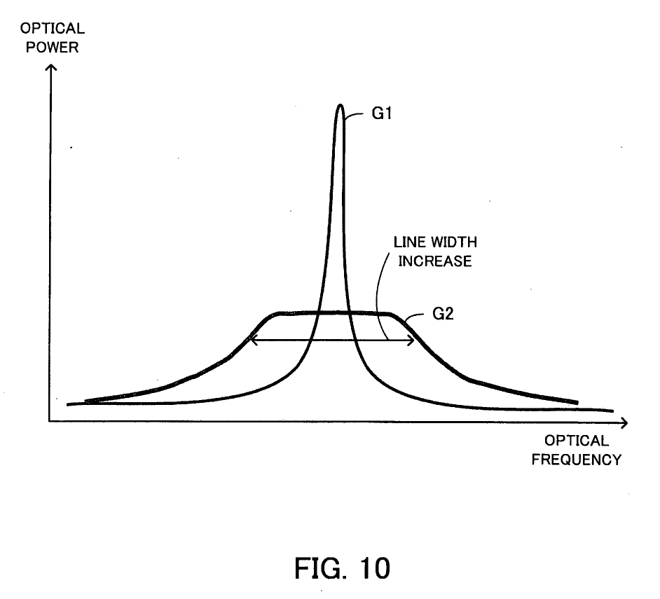

FIG. 11 is a block diagram of a conventional optical transmitter;

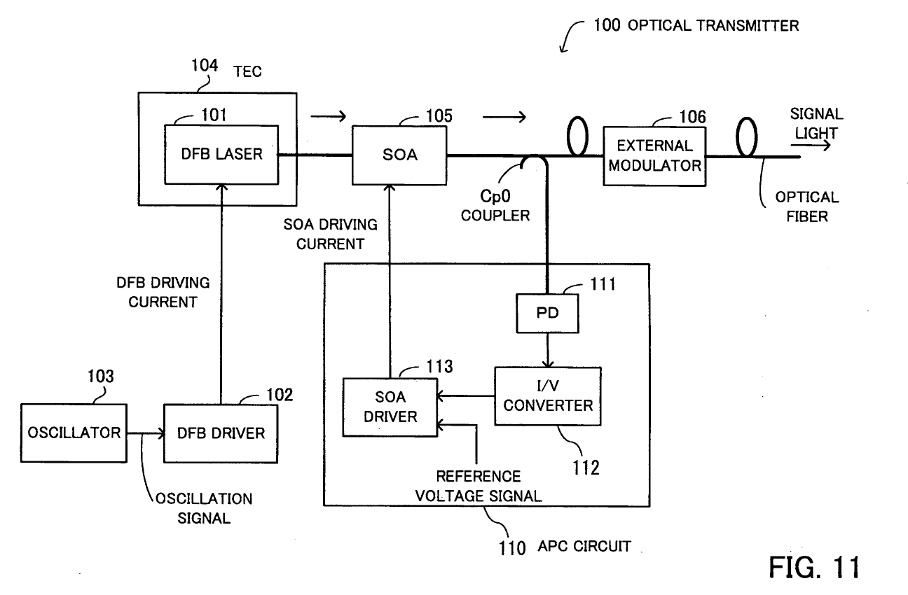

FIG. 12 illustrates a state where optical output fluctuates; and

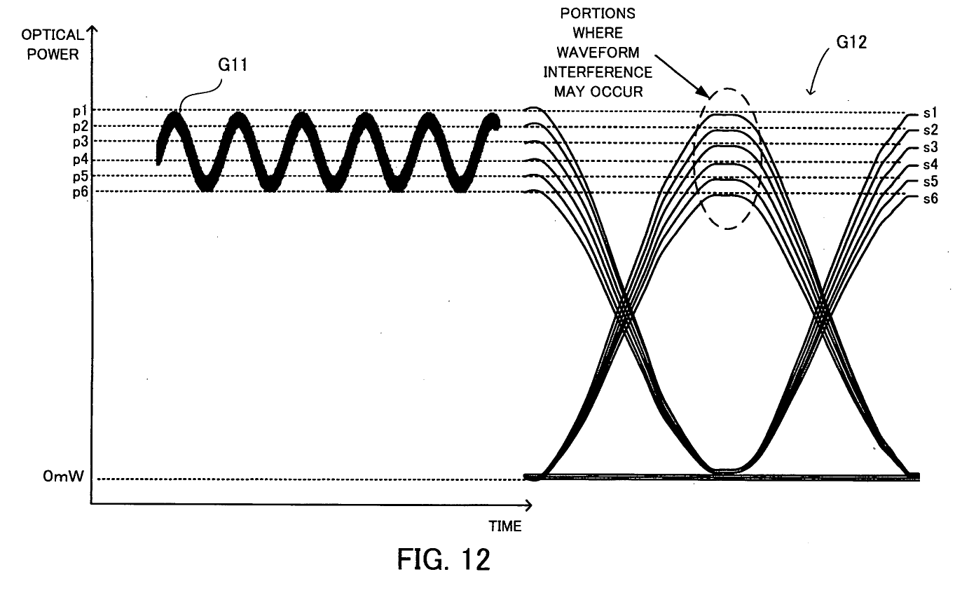

FIG. 13 illustrates transmission characteristics deterioration caused by waveform interference.

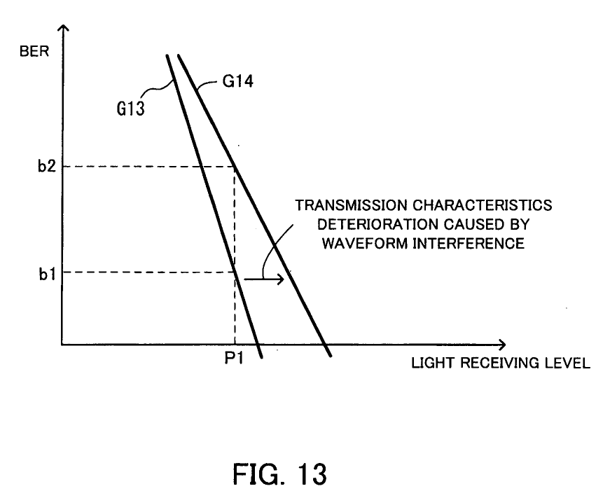

### DESCRIPTION OF EMBODIMENT(S)

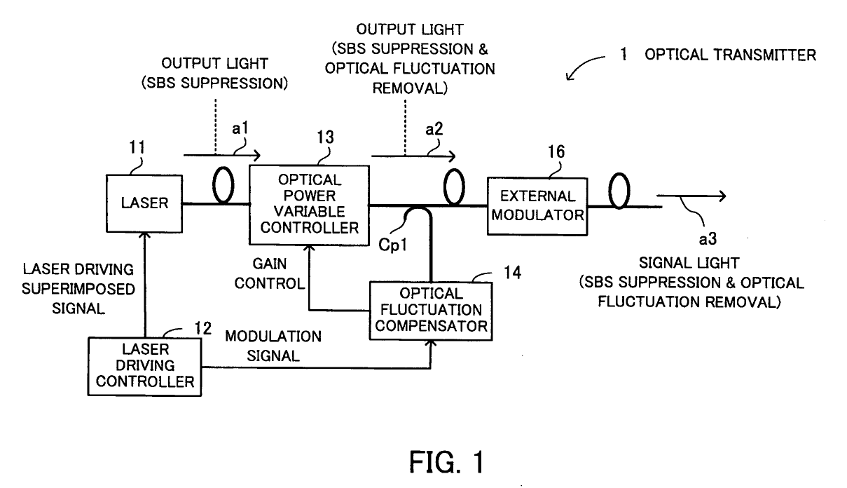

An embodiment of the present invention will be described below with reference to the accompanying drawings, wherein like reference numerals refer to like elements throughout. FIG. 1 is a principle view of an optical transmitter according to the embodiment. An optical transmitter 1 comprises a laser 11, a laser driving controller 12, an optical power variable controller 13, an optical fluctuation compensator 14, an external modulator 16 and a coupler Cp1.

The laser 11 emits light. The laser driving controller 12 controls driving of the laser 11. Specifically, the laser driving controller 12 superimposes a modulation signal on a driving signal for the laser to generate a laser driving superimposed signal and applies the laser driving superimposed signal to the laser 11 to cause wavelength fluctuations in high-intensity laser output light to suppress nonlinear optical phenomena (SBS: Stimulated Brillouin Scattering) which occur during optical fiber transmission.

The optical power variable controller 13 variably controls a power of the laser output light a1. The optical fluctuation compensator 14 suppresses the optical fluctuations. Specifically, the optical fluctuation compensator 14 monitors output light a2 from the optical power variable controller 13, which is branched by the coupler Cp1, to detect optical fluctuations (optical amplitude fluctuations) in the laser output light a1 accompanying the wavelength fluctuations in the laser output light a1. Then, the compensator 14 compares a phase of the modulation signal with a phase of the optical fluctuation signal to generate a gain compensation signal for suppressing the optical fluctuations. Then, the compensator 14 controls a gain of the optical power variable controller 13 based on the gain compensation signal. The external modulator 16 externally modulates the output light a2 from the optical power variable controller 13 to generate signal light a3 and transmits the signal light a3 through optical fibers.

The output light a1 is light whose wavelength is fluctuated by the laser driving superimposed signal to suppress SBS, and has optical fluctuations accompanying the wavelength fluctuations. The output light a2 is light from which optical fluctuations are removed by allowing the optical fluctuation compensator 14 to control a gain of the optical power variable controller 13.

Accordingly, when externally modulating the output light a2, the signal light a3 is generated which is fluctuated in wavelength to suppress SBS (increased in line width) but suppressed in optical fluctuations. Accordingly, there can be realized the optical fiber transmission capable of increasing the allowable optical power and suppressing the transmission characteristics deterioration which occurs when the SBS is suppressed.

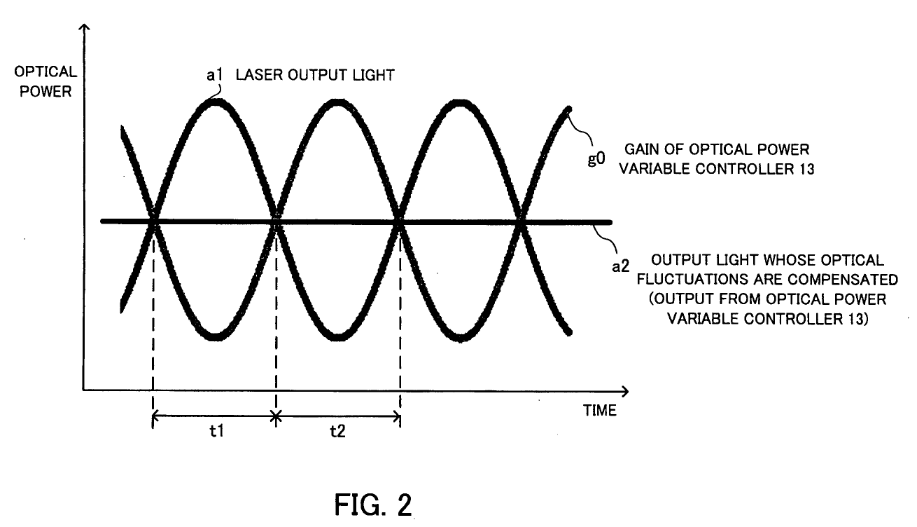

Next, control of compensation for optical fluctuations will be described. FIG. 2 illustrates a concept of the compensation for optical fluctuations. In FIG. 2, a horizontal axis indicates a time, and a vertical axis indicates an optical power. The optical power variable controller 13 is controlled by a gain go having an inversed waveform of the output light a1 (laser output light a1).

When controlling the optical power variable controller 13 by this gain g0, the laser output light a1 is compensated for by an inverted waveform. The compensation for optical fluctuations is controlled, for example, as follows. During a time period t1, a gain compensation amount of the optical power variable controller 13 is reduced to reduce an amplification gain such that the output light a1 is made flat. During a time period t2, a gain compensation amount of the optical power variable controller 13 is increased to increase an amplification gain such that the output light a1 is made flat. By this control, the output light a2 from which optical fluctuations has been removed is generated by the optical power variable controller 13.

The above FIG. 2 illustrates a state where the compensation by the optical power variable controller 13 is proper. As is apparent from FIG. 2, the optical fluctuations in the laser output light a1 caused by suppression of SBS is reasonably compensated for by the optical power variable controller 13 and as a result, the output light a2 is made flat and stable.

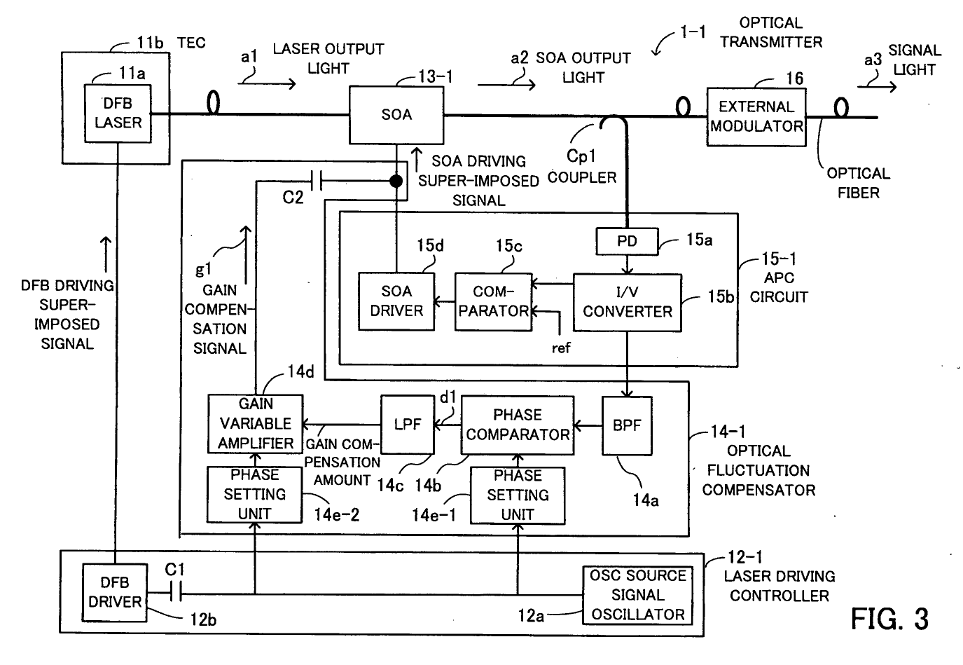

Next, a specific configuration and operation of the optical transmitter 1 will be described. FIG. 3 is a specific block diagram of the optical transmitter 1 according to the embodiment. An optical transmitter 1-1 illustrated in FIG. 3 comprises a DFB laser 11a, a TEC 11b, a laser driving controller 12-1, an SOA 13-1, an optical fluctuation compensator 14-1, an APC circuit 15-1, an external modulator 16 and a coupler Cp1. The SOA 13-1 corresponds to the optical power variable controller 13. In place of the SOA, a VOA (Variable Optical Attenuator) may be used.

The laser driving controller 12-1 includes an OSC (Optical Supervisor Channel) source signal oscillator 12a, a DFB driver 12b and a capacitor C1. The optical fluctuation compensator 14-1 includes a band-pass filter 14a, a phase comparator 14b, a low-pass filter 14c, a gain variable amplifier 14d, phase setting units 14e-1 and 14e-2, and a capacitor C2. The APC circuit 15-1 includes a PD 15a, an I/V converter 15b, a comparator 15c, and an SOA driver 15d.

The OSC source signal oscillator 12a oscillates an OSC source signal as a low-frequency modulation signal. The OSC source signal is supplied to the phase setting units 14e-1 and 14e-2, and the DFB driver 12b. The OSC source signal is a signal acting as a source signal of an OSC signal that is a supervisory-control optical signal used when supervising an apparatus state to perform communication with other apparatuses. Here, the OSC source signal is used not only as a source signal for generating an OSC signal but also as a modulation signal for suppressing SBS.

The DFB driver 12b generates a DFB driving superimposed signal for causing the OSC source signal, which is DC-cut by the capacitor C1, to fluctuate a DFB driving current with time to fluctuate an oscillation wavelength of the DFB laser 11a, and supplies to the DFB driving superimposed signal to the DFB laser 11a.

The DFB laser 11a as an LD (Laser Diode) light source is mounted on the TEC 11b (corresponding to a Peltier element) for performing temperature stabilization by being applied with electrical signals. The DFB laser 11a outputs the laser output light a1 whose optical wavelength is fluctuated based on the DFB driving superimposed signal.

The SOA 13-1 amplifies the laser output light a1 and outputs SOA output light a2. The coupler Cp1 branches the SOA output light a2 into two to give one branched light to the external modulator 16 and to give the other branched light to the APC circuit 15-1. The external modulator 16 externally modulates an intensity of the SOA output light a2 to generate signal light a3 having a predetermined transmission rate and transmits the signal light a3 through optical fibers.

In the APC circuit 15-1, the PD 15a monitors the SOA output light a2 and converts it into a current signal, and the I/V converter 15b converts the current signal into a voltage signal. Based on the incoming voltage signal and a previously set reference voltage ref, the comparator 15c generates such a control signal that the voltage signal from the I/V converter 15b has the same value as that of the reference voltage ref. The SOA driver 15d generates an SOA driving current based on the control signal, thereby performing a gain control (APC) such that an output power of the SOA 13-1 is kept constant.

In the optical fluctuation compensator 14-1, the band-pass filter 14a performs band-pass filtering on the output voltage signal from the I/V converter 15b to extract a frequency component of the optical fluctuations and outputs an optical fluctuation signal.

The phase setting unit 14e-1 is a delay setting unit for setting a delay generated in an analog circuit system or arithmetic processing within the optical transmitter 1-1. Specifically, the phase setting unit 14e-1 sets to the OSC source signal a delay amount which is necessary when an output phase of the band-pass filter 14a is compared with a phase of the OSC source signal.

The phase comparator 14b compares a phase of the optical fluctuation signal (hereinafter referred to as a BPF output) from the band-pass filter 14a with a phase of the OSC source signal (hereinafter referred to as an OSC source output) generated by the phase setting unit 14e-1 and having a predetermined delay amount, and outputs a phase detection signal d1 (phase detection result). The low-pass filter 14c makes the phase detection signal d1 flat to generate a gain compensation amount and applies the gain compensation amount to the gain variable amplifier 14d.

The phase setting unit 14e-2 has a function of setting a given delay to the OSC source signal, similarly to the phase setting unit 14e-1. Specifically, the phase setting unit 14e-2 sets to the OSC source output a delay amount corresponding to a phase shift necessary for the OSC source output to have an inverted waveform of the fluctuation waveform of the laser output light a1.

The gain variable amplifier 14d sets the gain compensation amount from the low-pass filter 14c to the OSC source output (phase shifted modulation signal) generated by the phase setting unit 14e-1 and having a predetermined delay amount, thereby generating a gain compensation signal g1.

The gain compensation signal g1 is DC-cut by the capacitor C2 and superimposed on the SOA driving current from the SOA driver 15d to generate an SOA driving superimposed signal. Then, the resultant SOA driving superimposed signal is applied to the SOA 13-1.

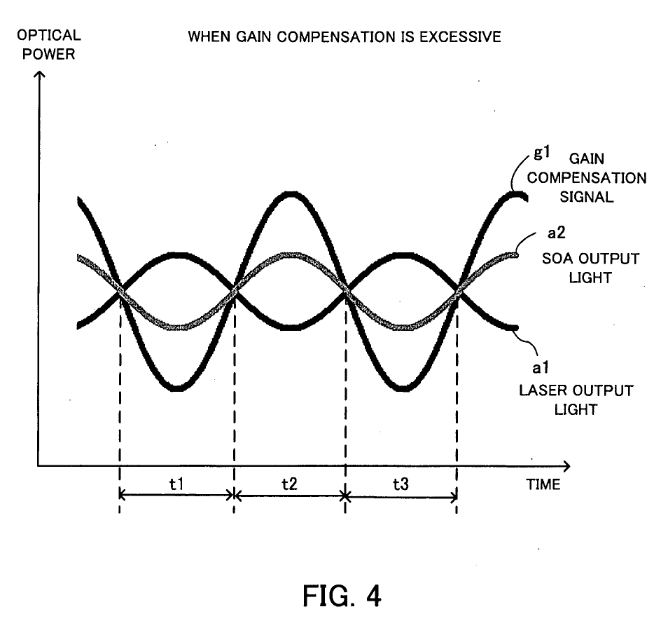

Next, control of compensation for optical fluctuations will be described. FIG. 4 illustrates a state in which the compensation for optical fluctuations is excessive. In FIG. 4, a horizontal axis indicates a time, and a vertical axis indicates an optical power. The optical fluctuations in the laser output light a1 is excessively compensated for by the SOA 13-1 (optical power variable controller 13). As a result, the SOA output light a2 is fluctuated by the gain compensation signal g1.

At this time, the SOA output light a2 and the gain compensation signal g1 are in phase with each other. Specifically, the SOA output light a2 and the gain compensation signal g1 both have a negative polarity during a time period t1, a positive polarity during a time period t2, and a negative polarity during a time period t3. Therefore, the SOA output light a2 and the gain compensation signal g1 are in phase with each other.

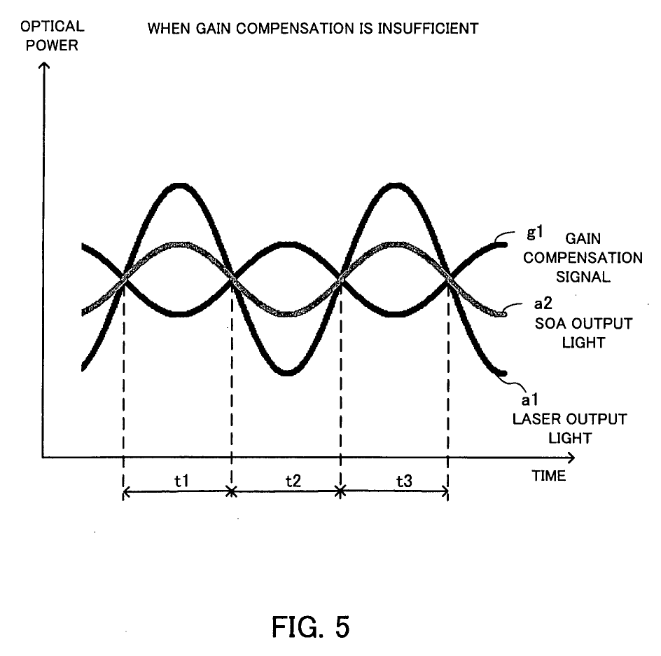

FIG. 5 illustrates a state in which the compensation for optical fluctuations is insufficient. In FIG. 5, a horizontal axis indicates a time, and a vertical axis indicates an optical power. The optical fluctuations in the laser output light a1 caused by suppression of SBS are insufficiently compensated for by the SOA 13-1. As a result, the SOA output light a2 still has optical fluctuations.

At this time, the SOA output light a2 and the gain compensation signal g1 are in opposite phase to each other. Specifically, the SOA output light a2 has a positive polarity and the gain compensation signal g1 has a negative polarity during the time period t1. The SOA output light a2 has a negative polarity and the gain compensation signal g1 has a positive polarity during the time period t2. The SOA output light a2 has a positive polarity and the gain compensation signal g1 has a negative polarity during the time period t3. Therefore, the SOA output light a2 and the gain compensation signal g1 are in opposite phase to each other.

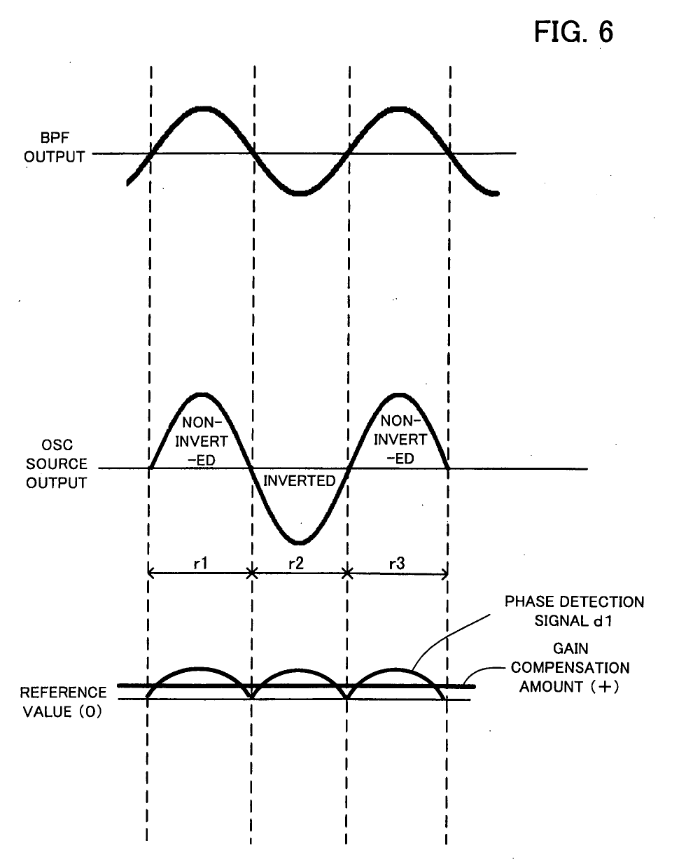

FIG. 6 illustrates generation of the gain compensation amount in the case where the compensation is excessive. When the gain compensation is excessive as illustrated in FIG. 4, a phase of the BPF output (corresponding to a phase of the SOA output light a2) and a phase of the OSC source output (corresponding to a phase of the gain compensation signal g1) are in phase with each other.

The phase comparator 14b compares the phases of the BPF output and the OSC source output in this phase state and outputs the phase detection signal d1. A phase comparison operation is performed as follows. When the OSC source output is a non-inverted output, the phase comparator 14b outputs a signal having the same polarity as that of the BPF output within a non-inversion region. When the OSC source output is an inverted output, the phase comparator 14b outputs a signal having an inverted polarity of the BPF output within an inversion region. Thus, the phase comparator 14b outputs the phase detection signal d1.

In the case of FIG. 6, the phase comparison operation is performed as follows. In the non-inversion region r1 of the OSC source output, since the BPF output has a positive polarity, the phase comparator 14b outputs the phase detection signal d1 having the same polarity as that of the BPF output, namely, having a positive polarity. In the inversion region r2 of the OSC source output, since the BPF output has a negative polarity, the phase comparator 14b outputs the phase detection signal d1 having an inverted polarity of the BPF output, namely, having a positive polarity. In the non-inversion region r3 of the OSC source output, since the BPF output has a positive polarity, the phase comparator 14b outputs the phase detection signal d1 having the same polarity as that of the BPF output, namely, having a positive polarity.

Accordingly, the phase comparator 14b outputs the phase detection signal d1 that is on the positive side of the reference value (0). The low-pass filter 14c receives the phase detection signal d1 and makes the signal d1 flat to generate a flat signal. This flat signal is used as the gain compensation amount (+).

The gain compensation amount (+) is applied to the gain variable amplifier 14d. When the gain compensation amount is positive, the gain variable amplifier 14d recognizes that a gain is excessive and performs control to reduce the gain to reduce the compensation amount.

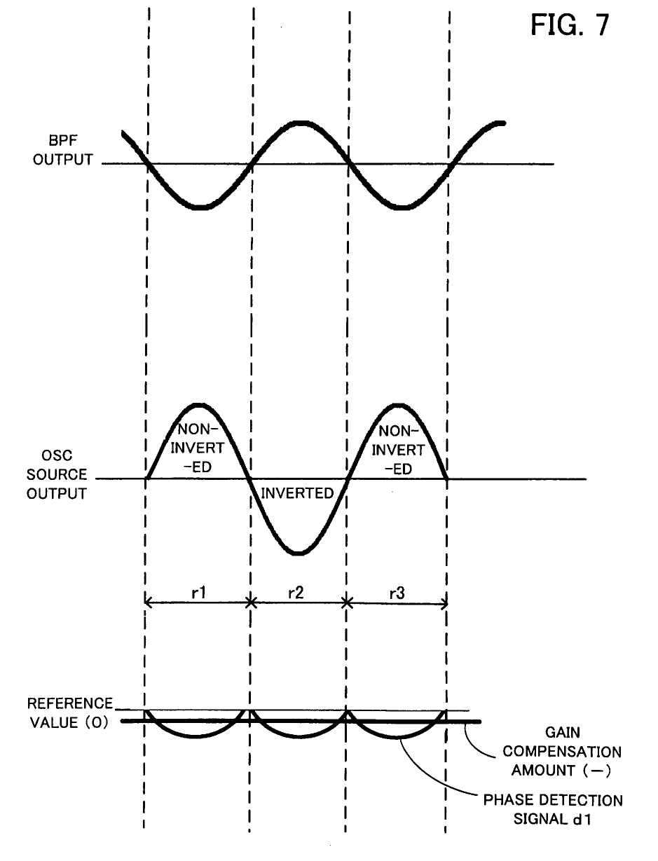

FIG. 7 illustrates generation of the gain compensation amount in the case where the compensation is insufficient. When the gain compensation is insufficient as illustrated in FIG. 5, a phase of the BPF output (corresponding to a phase of the SOA output light a2) and a phase of the OSC source output (corresponding to a phase of the gain compensation signal g1) are opposite to each other.

The phase comparator 14b compares the phases of the BPF output and the OSC source output in this phase state and outputs the phase detection signal d1. In the case of FIG. 7, the phase comparison operation is performed as follows. In the non-inversion region r1 of the OSC source output, since the BPF output has a negative polarity, the phase comparator 14b outputs the phase detection signal d1 having the same polarity as that of the BPF output, namely, having a negative polarity. In the inversion region r2 of the OSC source output, since the BPF output has a positive polarity, the phase comparator 14b outputs the phase detection signal d1 having an inverted polarity of the BPF output, namely, having a negative polarity. In the non-inversion region r3 of the OSC source output, since the BPF output has a negative polarity, the phase comparator 14b outputs the phase detection signal d1 having the same polarity as that of the BPF output, namely, having a negative polarity.

Accordingly, the phase comparator 14b outputs the phase detection signal d1 that is on the negative side of the reference value (0). The low-pass filter 14c receives the phase detection signal d1 and makes the signal d1 flat to generate a flat signal. This flat signal is used as the gain compensation amount (−).

The gain compensation amount (−) is applied to the gain variable amplifier 14d. When the gain compensation amount is negative, the gain variable amplifier 14d recognizes that a gain is insufficient and performs control to increase the gain to increase the compensation amount.

As seen from the block diagram of FIG. 3, the gain compensation signal g1 is applied, as an offset, from outside of an APC loop, and applied from a part unaffected by the time constant of the loop. Therefore, the compensation for optical fluctuations can be performed without being affected by the time constant of the APC loop.

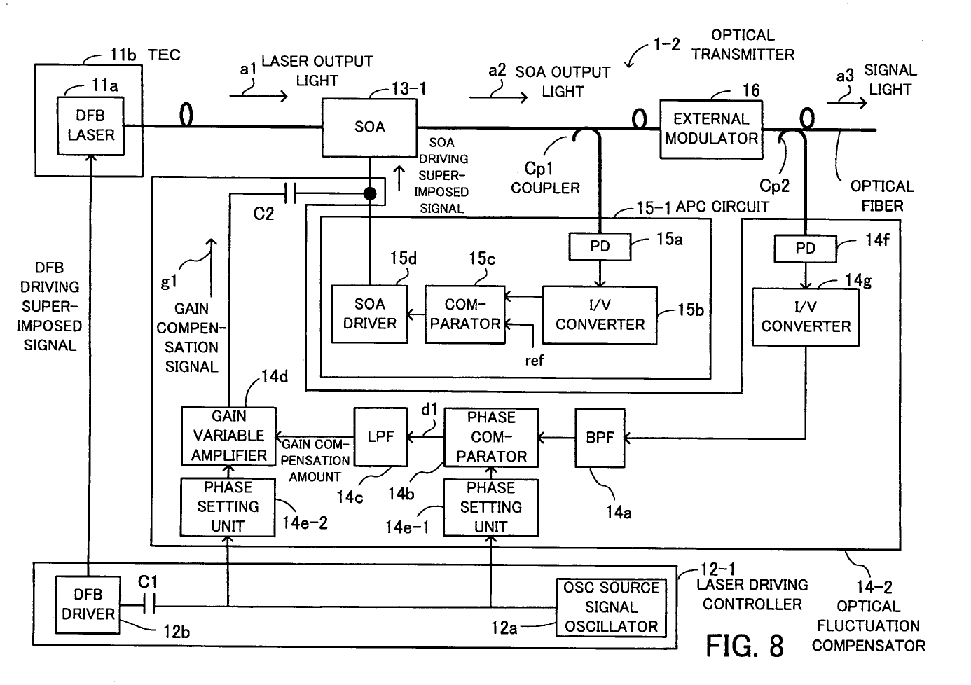

Next, other embodiments of the optical transmitter 1 will be described. FIG. 8 is another block diagram of the optical transmitter 1 according to the embodiment. The optical transmitter 1-1 illustrated in FIG. 3 feeds back the SOA output light a2 to perform the compensation for optical fluctuations. An optical transmitter 1-2 illustrated in FIG. 8 feeds back the signal light a3 generated by the external modulator 16 to perform the compensation for optical fluctuations.

The optical transmitter 1-2 comprises a DFB laser 11a, a TEC 11b, a laser driving controller 12-1, an SOA 13-1, an optical fluctuation compensator 14-2, an APC circuit 15-1, an external modulator 16, and couplers Cp1 and Cp2.

The laser driving controller 12-1 includes an OSC source signal oscillator 12a, a DFB driver 12b, and a capacitor C1. The optical fluctuation compensator 14-2 includes a band-pass filter 14a, a phase comparator 14b, a low-pass filter 14c, a gain variable amplifier 14d, phase setting units 14e-1 and 14e-2, a capacitor C2, a PD 14f, and an I/V converter 14g. The APC circuit 15-1 includes a PD 15a, an I/V converter 15b, a comparator 15c, and an SOA driver 15d.

The coupler Cp2 branches the signal light a3 from the external modulator 16. The PD 14f monitors the branched signal light a3 to generate a current signal. The I/V converter 14g converts the current signal into a voltage signal and supplies the voltage signal to the band-pass filter 14a. Since the other operations in FIG. 8 are the same as those described in FIG. 3, the description will not be repeated here.

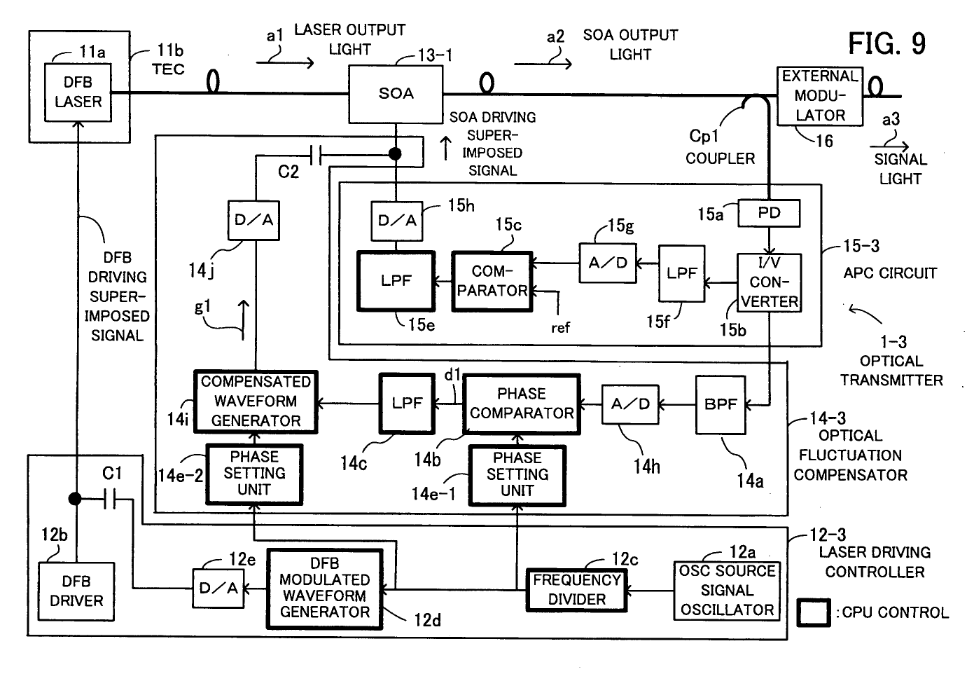

FIG. 9 is another block diagram of the optical transmitter 1 according to the embodiment. An optical transmitter 1-3 illustrated in FIG. 9 performs the compensation for optical fluctuations under CPU control (performs extraction of the gain compensation amount by means of arithmetic processing of a CPU). In FIG. 9, elements for performing a digital operation under the CPU control are surrounded by heavy lines.

The optical transmitter 1-3 comprises a DFB laser 11a, a TEC 11b, a laser driving controller 12-3, an SOA 13-1, an optical fluctuation compensator 14-3, an APC circuit 15-3, an external modulator 16, and a coupler Cp1.

The laser driving controller 12-3 includes an OSC source signal oscillator 12a, a DFB driver 12b, a frequency divider 12c, a DFB modulated waveform generator 12d, a D/A converter 12e, and a capacitor C1.

The optical fluctuation compensator 14-3 includes a band-pass filter 14a, a phase comparator 14b, a low-pass filter 14c, phase setting units 14e-1 and 14e-2, an A/D converter 14h, a compensated waveform generator 14i, a D/A converter 14j, and a capacitor C2. The APC circuit 15-3 includes a PD 15a, an I/V converter 15b, a comparator 15c, low-pass filters 15e and 15f, an A/D converter 15g, and a D/A converter 15h.

Since fundamental operations in FIG. 9 are the same as those described in FIG. 3, operations of elements related to the CPU control will be mainly described here. The frequency divider 12c divides the frequency of the OSC source signal to generate an oscillation frequency for suppression of SBS. The DFB modulated waveform generator 12d shapes the waveform of a low-frequency clock from the frequency divider 12c and sets the amplitude of the waveform, thereby generating a modulation signal.

The D/A converter 12e converts a digital modulation signal into an analog modulation signal. The modulation signal is DC-cut by the capacitor C1 and superimposed on a DFB driving signal from the DFB driver 12b to generate the DFB driving superimposed signal. Then, the DFB driving superimposed signal is applied to the DFB laser 11a.

The BPF output as an output signal from the band-pass filter 14a is converted into a digital signal by the A/D converter 14h and reaches the phase comparator 14b. The phase comparator 14b compares a phase of the digital BPF output with a phase of the low-frequency OSC source output generated by the phase setting unit 14e-1 and having a predetermined delay amount, and outputs a phase detection signal d1. The low-pass filter 14c makes the phase detection signal d1 flat to generate a gain compensation amount and applies the gain compensation amount to the compensated waveform generator 14i.

The phase setting unit 14e-2 sets to the OSC source output a delay amount corresponding to a phase shift necessary for the OSC source output to have an inverted waveform of the fluctuation waveform of the laser output light a1. The compensated waveform generator 14i sets the gain compensation amount from the low-pass filter 14c to the OSC source output generated by the phase setting unit 14e-2 and having a predetermined delay amount, thereby generating a gain compensation signal g1.

The gain compensation signal g1 is converted into an analog signal by the D/A converter 14j and is DC-cut by the capacitor C2. Then, the resultant gain compensation signal g1 is superimposed on the driving current for the SOA 13-1 from the D/A converter 15h to generate an SOA driving superimposed signal. Then, the SOA driving superimposed signal is applied to the SOA 13-1.

To reduce occurrence of nonlinear optical phenomena during optical fiber transmission, optical fluctuations accompanying fluctuations in an optical wavelength are removed to suppress transmission characteristics deterioration, whereby a high quality optical transmission can be performed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that various changes, substitutions and alterations could be made hereto without departing from the spirit and scope of the invention.

What is claimed is:

1. An optical transmitter for performing optical transmission, comprising:
a laser which emits light;
a laser driving controller which controls driving of the laser by superimposing a modulation signal on a driving signal for the laser to generate a laser driving superimposed signal and by applying the laser driving superimposed signal to the laser to cause wavelength fluctuations in laser output light to suppress nonlinear optical phenomena which occur during optical fiber transmission;
an optical power variable controller which variably controls a power of the laser output light; and
an optical fluctuation compensator which suppresses optical fluctuations by monitoring output light from the optical power variable controller to detect the optical fluctuations accompanying the wavelength fluctuations from monitoring results and by controlling a gain of the optical power variable controller.

2. The optical transmitter according to claim 1, wherein:
the optical fluctuation compensator suppresses the optical fluctuations by a process comprising:
filtering a monitor signal to extract an optical fluctuation signal having a frequency component of the optical fluctuations, the monitor signal being obtained by monitoring the optical power variable controller;
comparing a phase of the modulation signal with a phase of the optical fluctuation signal to generate phase comparison results as a gain compensation amount;
shifting the phase of the modulation signal so as to have an inverted waveform of the laser output light and setting the gain compensation amount to a phase shifted modulation signal to generate a gain compensation signal, the phase shifted modulation signal being the modulation signal having the phase shifted;
superimposing the gain compensation signal on a driving signal for the optical power variable controller to generate a driving superimposed signal; and
applying the driving superimposed signal to the optical power variable controller to control the gain of the optical power variable controller.

3. The optical transmitter according to claim 2, wherein:
the optical fluctuation compensator performs the phase comparison operation by a process comprising:
outputting, as the phase comparison results in a non-inversion region of the fluctuation signal, a signal having the same polarity as that of the optical fluctuation signal within the non-inversion region;
outputting, as the phase comparison results in an inversion region of the modulation signal, a signal having an inverted polarity of the optical fluctuation signal within the inversion region;
making the phase comparison results flat to generate the gain compensation amount;
recognizing, when the gain compensation amount is positive, that a gain now applied to the optical power variable controller is excessive, and generating the gain compensation signal whose gain is reduced to reduce the compensation amount; and
recognizing, when the gain compensation amount is negative, that a gain now applied to the optical power variable controller is insufficient, and generating the gain compensation signal whose gain is increased to increase the compensation amount.

4. The optical transmitter according to claim 1, further comprising an Auto Power Control (APC) circuit which monitors output light from the optical power variable controller and keeps constant a power of the output light such that a monitored value is equal to a predetermined reference value;
wherein the optical fluctuation compensator applies as an offset the gain compensation signal from outside of an APC loop.
